(19) United States
(12) Patent Application Publication
(10) Pub. No.: US 2020/0042964 A1
(43) Pub. Date: Feb. 6, 2020

(54) COMPUTER NETWORK SYSTEM AND PROCESS FOR COLLECTING TAX ON ONLINE COMMERCE

(71) Applicant: NETSWEEPER (BARBADOS) INC., St. Michael (BB)

(72) Inventors: Perry ROACH, Waterloo (CA); Lou ERDELYI, Waterloo (CA)

(21) Appl. No.: 16/498,368

(22) PCT Filed: Mar. 28, 2018
(86) PCT No.: PCT/IB2018/052108

§ 371 Date: Sep. 26, 2019

Related U.S. Application Data
(60) Provisional application No. 62/477,905, filed on Mar. 28, 2017.

(51) Int. Cl. G06Q 20/10; G06Q 30/02

(52) U.S. Cl. CPC G06Q 20/10; G06Q 30/0283

(57) ABSTRACT

Transaction data is received from a payment gateway over a computer network. The transaction data represents a pending transaction between a remote computer and an online merchant system. The transaction data includes a location of the transaction and an amount of the transaction. The transaction data is applied to a database to obtain tax data for the pending transaction and the tax data is transmitted to the payment gateway. Subsequently, a transaction record representative of execution of the pending transaction is received from the payment gateway. The transaction record is stored in a data store. A record storage confirmation indicator is transmitted to the payment gateway over the computer network.

### FIELD

This invention relates to computer systems, more specifically, to systems for online/internet commerce.

### BACKGROUND

Taxation is a critical function of any government.

The internet facilitates tax-free shopping. In fact, no-tax shopping has become a prime lure of online retailers looking to hook consumers on click-and-charge buying. Most internet sales are subject to sales tax, despite the fact that many sites do not collect sales tax. Consumers in the USA, for example, are technically responsible for remitting any unpaid sales tax on online purchases directly to their local governments.

Various tax jurisdictions in the world have different laws and methods of tax collection. In one US example, if an online retailer has a physical presence in a particular jurisdiction, such as a store, business office, or warehouse, it must collect sales tax from customers who are also within that jurisdiction. For instance, if a business does not have a physical presence in a particular state, it is not required to collect sales tax for sales into that state. This rule is derived from a 1992 US Supreme Court decision which held that mail-order merchants did not need to collect sales taxes for sales into jurisdictions where they did not have a physical presence.

Consumers who live in a jurisdiction that collects sales tax are technically required to pay the tax to the government even when an internet retailer fails to collect it. When consumers are required to pay tax directly to the state, it is referred to as “use” tax rather than sales tax.

The main difference between sales tax and use tax is who—the seller or the buyer—pays the government. Use taxes tend to be a contingency to ensure that a government can collect revenue on every taxable item that is purchased within its borders. However, because collecting use tax on smaller purchases is a major technical and logistical challenge, jurisdictions have traditionally attempted to collect use tax only on high-value items, such as those that require licenses (e.g., cars, boats, etc.).

However, circumstances are slowly changing. Many governments have re-evaluated their attitude towards collecting use taxes. For example, New York State has added a line to income tax returns requiring all residents to calculate how much they should pay on internet, mail order, or out-of-state purchases. California has begun a campaign to educate taxpayers on what is owed, as well.

Education and selective enforcement can only go so far. What is needed is a technical solution to the technical problem of collecting a vast number of individually small amounts of use/sales tax.

Others have developed systems that attempt to address this need. However, many such systems have faults or disadvantages that prevent wide-spread adoption.

In U.S. Pat. No. 8,700,504, Barsade teaches a system and method for calculating, collecting and/or disbursing one or more third party payments owed to one or more third parties resulting from one or more electronic transactions occurring over a wide-area network between a customer and a merchant. However, this technique requires tight integration with a payment gateway or merchant bank, such as the insertion of a software agent into the payment gateway or merchant bank system.

In U.S. Pat. No. 8,719,126, Hall et al. teach tax collection tools and techniques that automatically and electronically separate tax amounts from other funds in a commercial transaction, and divert the collected tax into a holding fund. However, as with Barsade's teachings, these techniques require that a software module be installed at a payment gateway or point-of-sale system.

In US 2004/0181470, Grounds teaches techniques for calculating tax amounts for online transactions and collecting tax due. However, this technique presents tax liabilities to merchants to collect and thereby relies on cooperation from a large number of merchants to be effective on a large scale.

In US 2014/0379531, Huang et al. teach collection of tax in real time from customers conducting online purchases. Merchants in the system do not conduct tax calculations and will not receive tax revenue payments, and thus will not be required to maintain and provide reports to tax authorities. Tax revenue is collected by a third party authorized by the respective participating tax authority. However, this technique is integrated at merchants' electronic shopping carts and thus, similar to Grounds, requires cooperation from a large number of merchants.

In US 2003/0097303, Agee et al. teach a system and a method for collection and distribution of sales taxes on a rapid basis that can be used for face-to-face, e-commerce, telephone, or other transactions. A central financial entity to distributes tax amounts to taxing entities. Further, the merchant is generally relied upon to compute and/or collect the tax amounts that ultimately flow into the account of the central financial entity. As such, this technique relies on some degree of merchant awareness and cooperation.

In view of the above, it should be apparent that known techniques provide inadequate or impractical solutions to the problem of collecting a vast number of individually small amounts of use/sales tax.

### SUMMARY

According to various aspects of the present invention, transaction data is received from a payment gateway over a computer network. The transaction data represents a pending transaction between a remote computer and an online merchant system. The transaction data includes a location of the transaction and an amount of the transaction. The transaction data is applied to a database to obtain tax data for the pending transaction and the tax data is transmitted to the payment gateway. Subsequently, a transaction record representative of execution of the pending transaction is received from the payment gateway. The transaction record is stored in a data store. A record storage confirmation indicator is transmitted to the payment gateway over the computer network.

### BRIEF DESCRIPTION OF THE DRAWINGS

The drawings illustrate, by way of example only, embodiments of the present invention.

FIG. 1 is a diagram of an electronic commerce system including a transaction control system for recording online transactions and tax amounts thereof.

FIG. 2 is a signal diagram of a process of conducting online transactions.

FIGS. 3A-3D are code snippets for data communications within the system.

FIG. 4 is a diagram of data structures for transaction records.

FIG. 5 is a diagram of an example implementation for the transaction control system, the tax computation system, and the transaction data store.

FIG. 6 is a diagram of a portion of the electronic commerce system including infrastructure configured control requests to payment gateways.

### DETAILED DESCRIPTION

The present invention aims to solve at least one of the problems discussed above. Specifically, various embodiments of the present invention provide for tracking and storing online sales transactions processed by payment gateways, for reporting transactions and tax amounts collected to taxation authorities, and blocking a payment gateway from operating in a tax jurisdiction if the payment gateway fails to facilitate tax collection.

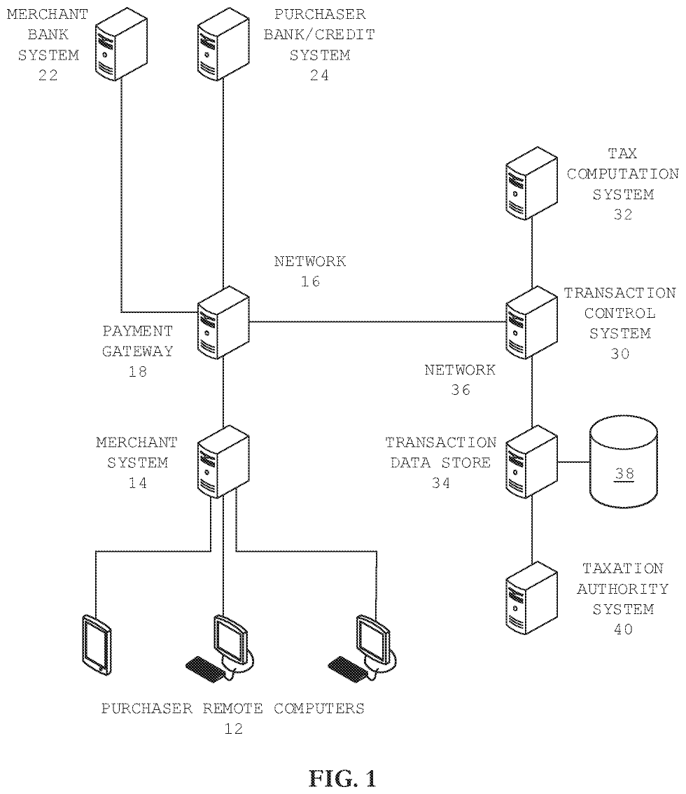

FIG. 1 shows an electronic commerce system including a transaction control system according to the present invention.

Remote computers 12 and merchant systems 14 are connected by a wide-area computer network 16 such as the Internet. Remote computers 12 (e.g., desktop computers, laptop computers, smartphones, tablet computers, and the like) are operated by purchasers who wish to buy goods/services from online merchant systems 14. The goods/services sold by the merchant systems 14 are not particularly limited and can include physical goods/services (e.g., shoes, concert tickets, etc.) and virtual goods/services (e.g., online employment ads, in-app purchases, etc.).

The merchant systems 14 are connected to payment gateways 18 through the computer network 16. Each merchant system 14 uses one or more payment gateways 18 to complete transactions with the purchasers are remote computers 12.

The payment gateways 18 are connected to various financial institutions, such as, for example, merchant bank systems 22 and bank or credit card systems 24 used by purchasers that operate the remote computer 12.

For a particular transaction between a purchaser at a remote computer 12 and a merchant system 14, the relevant payment gateway 18 is instructed to execute the transaction with the merchant bank system 22 and the purchaser's bank or credit card system 24.

The payment gateways 18 are configured to ensure that any required tax is paid on transactions between purchasers at remote computers 12 and merchant systems 14. The payment gateways 18 include tax in all relevant transactions and such tax may be a sales tax or use tax.

To achieve this, the payment gateways 18 are configured to communicate with a transaction control system 30 via the network 16. Each payment gateways 18 is configured with an application programming interface (API), web service, or other interface operable to receive communications from the transaction control system 30. The transaction control system 30 provides the payment gateways 18 with appropriate tax values for pending transactions, logs transactions executed by payment gateways 18, and may also be configured to trigger the dissociation of a payment gateway 18 that fails to comply with taxation requirements.

The transaction control system 30 is connected to a tax computation system 32 and a transaction data store 34. Such connections may use the wide-area computer network 16. It is contemplated that the transaction control system 30 and the transaction data store 34 will exist on the same local computer network 36, which is in communication with the wide-area computer network 16.

For pending transactions, the transaction control system 30 is configured to receive tax queries from the payment gateways 18 and to obtain tax data from the tax computation system 32. Tax queries can include information such as location of purchaser, location of seller, a list of goods/services, good/service tax codes/status, categories for goods/services (in the case where taxes are dependent on category), or similar information that enables the tax computation system 32 to identify the proper tax jurisdiction and compute the proper tax rate(s)/amount(s) for the transaction.

For executed transactions, the transaction control system 30 is configured to transaction records in a data store 34 and, upon successful storage of a transaction record, transmit a record storage confirmation indicator to the corresponding payment gateway 18. The record storage confirmation indicator can be used by the payment gateway 18 as a condition for reporting execution of the transaction to the online merchant system 14 involved in the transaction.

The transaction control system 30 includes one or more servers or other computers configured with an API, web service, or other interface operable to respond to requests for tax data from payment gateways 18 and operable to receive and store transaction records received from payment gateways 18. The transaction control system 30 is configured to make requests to an API, web service, or similar of the tax computation system 32 and receive tax data in response. Tax data includes the tax jurisdiction for the sale. The transaction control system 30 is configured to transmit transaction records to the transaction data store 34 for long-term storage for auditing, compliance, or other purposes.

The transaction data store 34 includes one or more servers or other computers and a data store 38 that can include one or more relational databases, which may be shards. The transaction data store 34 is configured to receive transaction records for executed transactions from the transaction control system 30 via an API, web service, or similar. Each transaction record stores a merchant identifier, a transaction date, a transaction amount, a tax amount, a tax jurisdiction, a currency, a payment type (e.g., credit card, debit, etc.) and may further store a list of the good(s)/service(s) sold. The transaction data store 34 is further configured to report transaction records to one or more taxation authority systems 40.

The transaction data store 34 is configured to store transaction record for a predetermined time, such as seven years.

A taxation authority system 40 is operated by the tax jurisdiction for a particular location (e.g., a country). The transaction data store 34 is configured to provide reports of the transaction records collected for the particular location for each taxation authority system 40 by executing queries on transaction records with reference to tax jurisdiction. Transaction data can include an authority code, which may be a unique code that identifies a country, state, province, region, county, city, or other location where tax is payable. Transaction data may then be filtered based on authority code, so that each taxation authority system 40 is provided with the relevant transaction data. Authority codes can be hierarchically structured, so that higher authorities can view transaction data for subordinate authorities. Reports can indicate total value of online purchases as well as total tax collected.

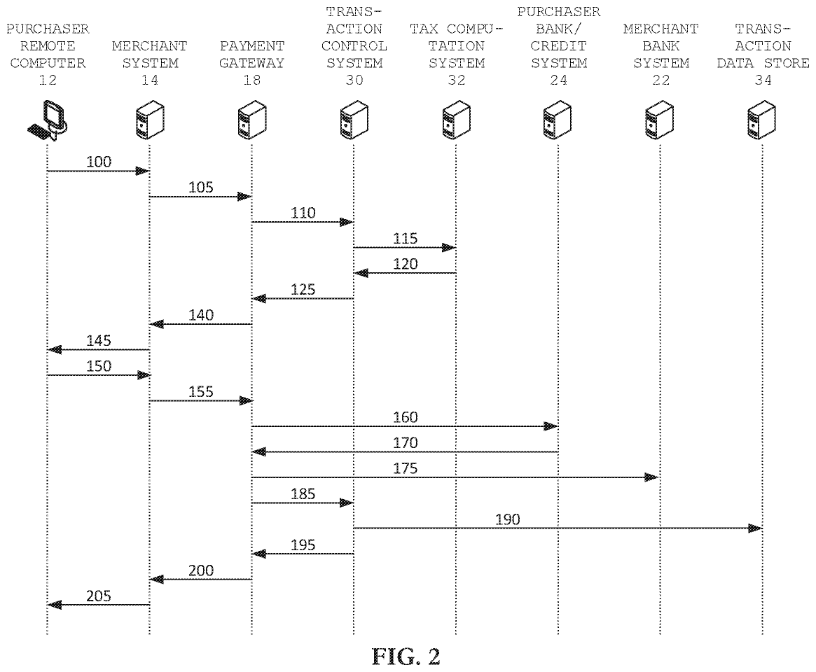

FIG. 2 shows a process of conducting online transactions according to the present invention. Unless otherwise specified, all communications occur over the wide-area computer network 16.

A user (purchaser) at a remote computer 12 initiates a checkout process through a web browser, application, or other user agent by transmitting a checkout request 100 to the relevant merchant system 14. The checkout process relates to one or more goods/services (item) that the user wishes to buy, and such item or items may be defined by an electronic shopping cart or similar data structure at the merchant system 14. The checkout request 100 includes an indication of the location of the purchaser, if not already stored at the merchant system 14, and can include payment information as well.

The merchant system 14 computes the total amount for the item or items, if not already computed, and transmits a pending transaction 105 to the payment gateway 18. The pending transaction 105 includes at least the location of the purchaser and/or the location of the merchant and the total amount, and may further include a list of item/items being purchased or categories (e.g., food, household goods, etc.) thereof.

According to the present invention, the payment gateway 18 communicates with the transaction control system 30.

The payment gateway 18 transmits data 110 of the pending transaction 105 to the transaction control system 30. That is, transaction data 110, such as at least location and total amount, are provided by the payment gateway 18 to the transaction control system 30. To achieve this, the payment gateway 18 can communicate with an API, web service, or similar interface of the transaction control system 30 and provide the transaction data 110 as a structured data element (e.g., an Extensible Markup Language or XML file). The payment gateway 18 stores the protocol, address, authentication information (e.g., a certificate), and other connection data needed to communicate with the transaction control system 30. The payment gateway 18 holds the pending transaction 105 in memory, such as in a queue, while waiting for a response from the transaction control system 30. The payment gateway 18 can be configured with a queue management process to resend a transaction data 110 to the transaction control system 30 after a period in which no response was received, to reconcile data received from the transaction control system 30 with the queue of pending transactions 105, and to dequeue pending transactions 105 for which data is received from the transaction control system 30.

The payment gateway 18 can connect to an address of a backup transaction control system 30 should the initial transaction control system 30 be non-responsive for a predetermined period.

Advantageously, the payment gateway 18 does not require a specialized software agent/client nor is it required to perform tax computations. Rather, the payment gateway 18 need only be configured for basic network data communications with the transaction control system 30.

The transaction control system 30 receives the transaction data 110 and provides query data 115 to the tax computation system 32 for the computation of one or more tax amounts for the pending transaction 105. Query data 115 can include all or a portion of the transaction data 110. Query data 115 includes at least a location for the pending transaction 105 and this may include the location of the purchaser, the location of the merchant, or both. It is contemplated that, in many scenarios, the location of the purchaser will govern tax amounts. Query data 115 can further include a list of the item or items being purchased or one or more categories of such item or items. This can be used to compute item-based tax amounts, where some items may be subject to different tax rates or may be tax exempt.

The tax computation system 32 applies the query data 115 to its database and computation engine and responds to the transaction control system 30 with tax data 120 indicative of the total tax amount for the pending transaction. The tax data can further include one or more of item-based tax amounts, a total tax rate, item-based tax rates, or similar for display to the purchaser. If the tax computation system 32 is unavailable (e.g., cannot be reached via the network) or if the tax computation system 32 fails to provide appropriate tax data 120, then the transaction control system 30 can perform a failsafe computation. An example failsafe computation is applying one simple percentage to the total transaction amount, irrespective of the number and category of items being purchased.

The transaction control system 30 transmits an indication 125 of the tax data for the pending transaction to the payment gateway 18, through the payment gateway's API or other interface, as a response to the transaction data 110 provided by the payment gateway 18. The indication 125 includes the total tax amount and may further include any item-based tax amounts, a total tax rate, item-based tax rates, or similar.

The payment gateway 18 updates the pending transaction 105 with the tax amount. At this time, the payment gateway 18 can send data 140 for the updated pending transaction, specifically, the tax amount or the updated pending transaction including the tax amount, to the merchant system 14 which transmits such data 145 to the remote computer 12 and receives a confirmation or cancellation request 150 from the remote computer 12. That is, the purchaser has the opportunity to cancel the transaction upon seeing the tax amount. The merchant system 14 then transmits a conformation or cancellation request 155 to the payment gateway 18. Confirmation requests 150, 155 can include payment information, if not already provided to the payment gateway 18. The tax amount is added to the original total amount, which is a pre-tax amount.

Alternatively, the merchant system 14 is configured for tax-inclusive pricing and the purchaser has already agreed to the transaction by making the request 100. In this case, the payment gateway 18 can compute a pre-tax amount by reducing the total amount received with the pending transaction 105 by the tax amount received from the transaction control system 30, if the pre-tax amount is needed. The total amount is the same as provided by the merchant system 14 in the pending transaction 105.

The updated pending transaction at the payment gateway 18 uses a similar or identical data structure as the original pending transaction 105.

After updating the pending transaction and, depending on the implementation, requesting confirmation from the remote computer 12, the payment gateway 18 transmits the transaction 160, which includes payment information (e.g., credit card details) to the bank system.

The payment gateway 18 submits the relevant payer and payee data to the purchaser's bank or credit card system 24, which approves the transaction and responds with an authorization/transaction code 170. The payment gateway 18 transmits the authorization/transaction code 175 to the merchant bank system 22.

It should be understood that various transaction execution methodologies exist and the methodology described above with respect to the payment gateway 18 and the bank/credit systems 22, 24 is but one example. Numerous other transaction execution methodologies fall within the scope of the present invention.

The payment gateway 18 transmits the transaction record 185 to the transaction control system 30.

The transaction control system 30 receives the transaction record 185 and transmits the transaction record 190 to the transaction data store 34, which stores the transaction record 190. The transaction control system 30 can provide a confirmation of storage to the transaction control system 30. Alternatively, the transaction control system 30 can consider all sent transaction records 190 to be successfully stored.

The transaction control system 30 transmits a record storage confirmation indicator 195 to the payment gateway 18.

In some embodiments, the payment gateway 18 uses the record storage confirmation indicator 195 as a condition for reporting execution of the transaction to merchant system 14. That is, the payment gateway 18 does not report transaction success to the merchant system 14 until the payment gateway 18 receives a valid record storage confirmation indicator 195 for the transaction. The payment gateway 18 can retry transmitting the transaction record to the transaction control system 30 according to a predetermined timeout after not receiving a record storage confirmation indicator 195. This can advantageously ensure that tax has been tracked and scheduled to be paid prior to the merchant system 14 releasing the good/service to the purchaser.

Subsequently, the payment gateway 18 transmits a success indication 200 to the merchant system 14 showing that the transaction was successful and indicating any amount(s) of tax that is due to be paid. The merchant system 14 displays a notification 205 to the purchaser at the remote computer 12 indicating that the purchase was successful. Then, the merchant begins its order fulfillment process, including shipping, if needed.

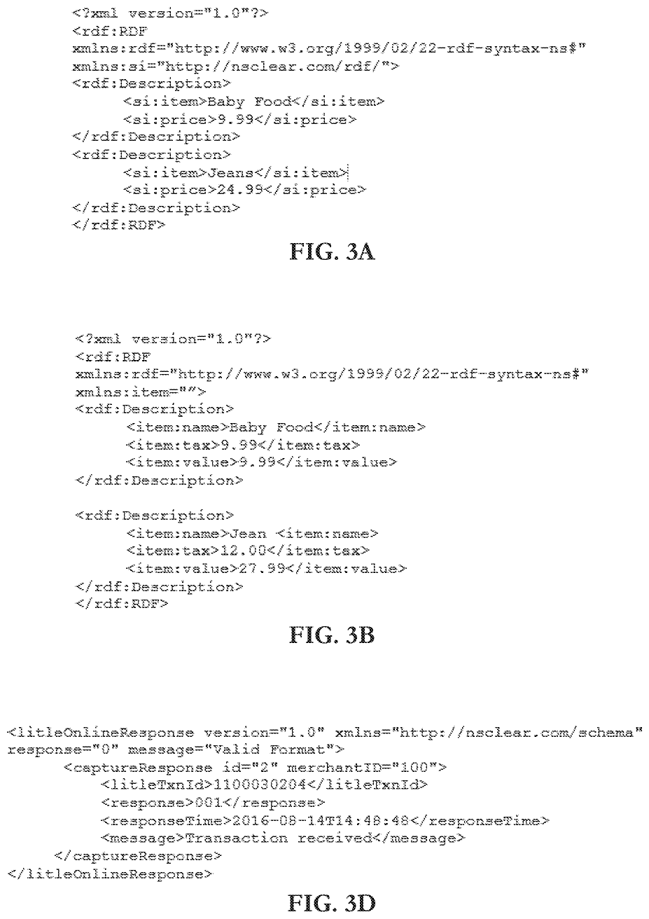

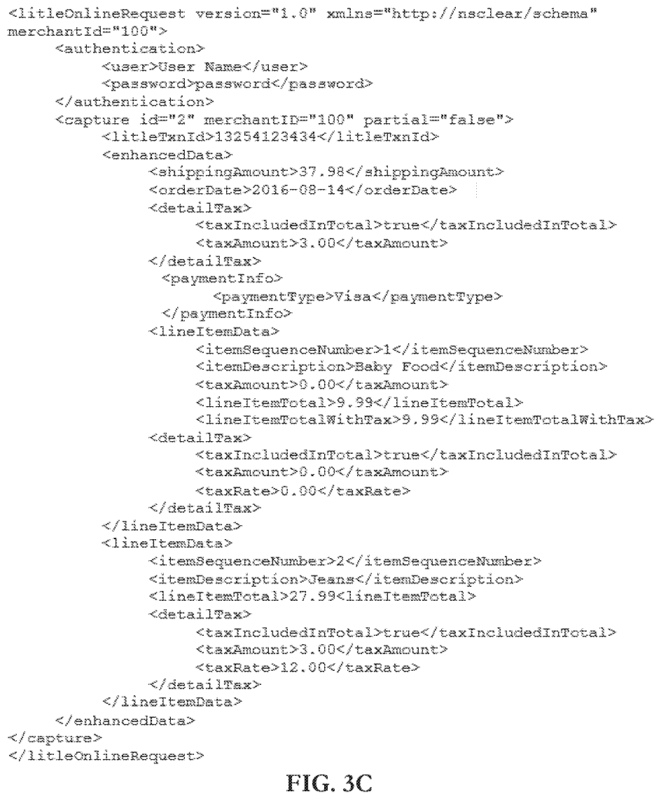

FIGS. 3A-3D show code snippets for some of the data communications within the system. The code accords with a Simple Object Access Protocol (SOAP), but this is not to be taken as limiting and other protocols and techniques are contemplated.

FIG. 3A shows example XML code that a payment gateway 18 uses to connect to the transaction control system 30 to query the lookup of any tax for each item in a pending transaction.

FIG. 3B shows example XML code that the transaction control system 30 uses to respond to the payment gateway 18 tax data and a new tax-inclusive amount for each item, after the transaction control system 30 looks up each item as defined in one or more Resource Description Framework (RDF) calls against the tax computation system 32.

FIG. 3C shows example XML code for a transaction record that the payment gateway 18 submits to the transaction control system 30 to indicate that the transaction was successful (i.e., payment was completed).

FIG. 3D shows example XML code for a record storage confirmation indicator sent as a response from the transaction control system 30 to the payment gateway 18.

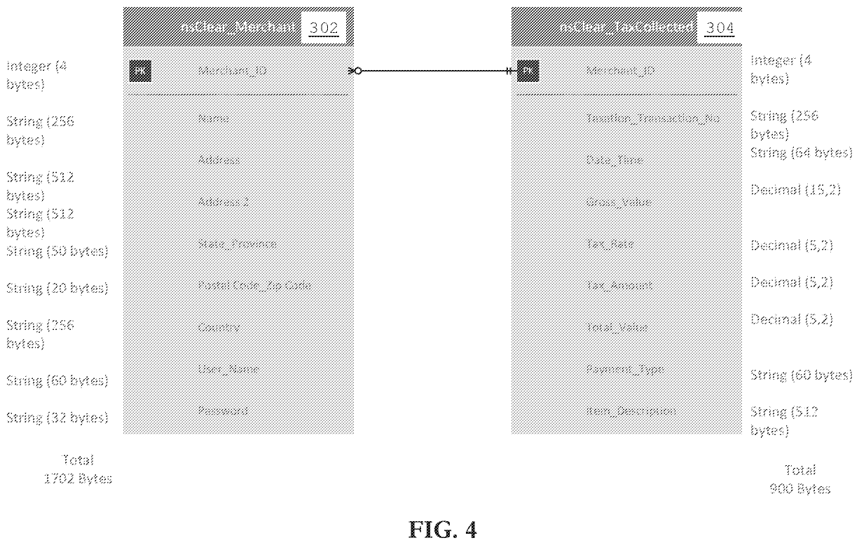

FIG. 4 shows a database structure suitable for efficiently storing a multitude (millions) of transaction records at the transaction data store 34 for an appropriate retention period of, for example, seven years. A merchant table 302 stores a unique identifier of each merchant operating one or more merchant systems 14 in association with particulars about the merchant. A tax collected table 304 stores transaction records for items, where each row corresponds to one item. Because a particular transaction may include multiple items, a transaction number/identifier field is provided to allow each row to be assigned to an actual transaction. The tax collected table 304 stores other data concerning the transaction, such as the identifier of the merchant, value/amount, tax rate, tax amount, date, payment type, and a description of the item. The tax collected table 304 and merchant table 302 are linked by merchant identifier, so that the total tax collected for a particular merchant can be efficiently calculated.

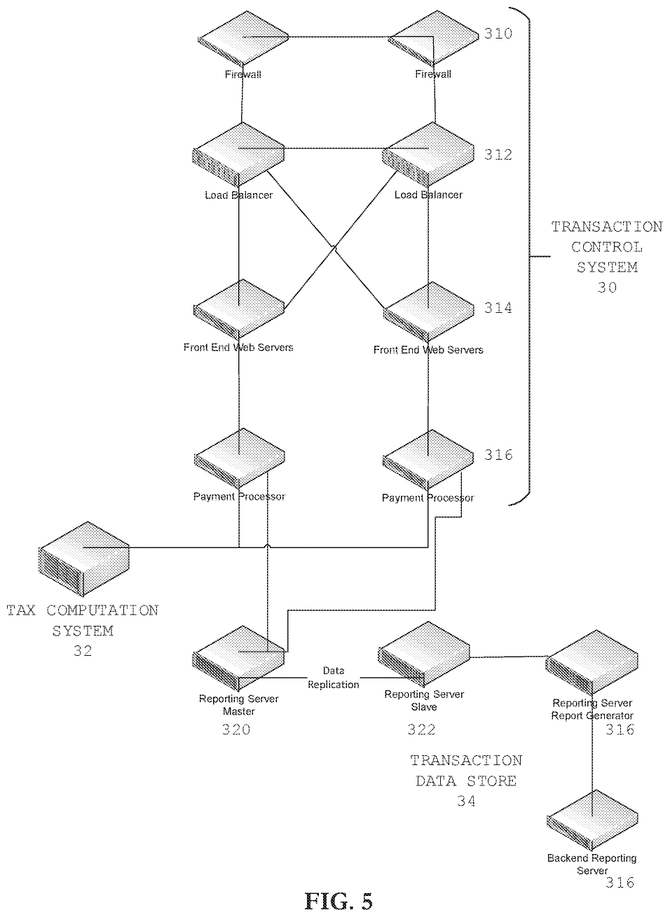

FIG. 5 shows an example implementation for the transaction control system 30, the tax computation system 32, and the transaction data store 34.

The transaction control system 30 includes one or more firewalls 310, load balancers 312, frontend web servers 314, and processing servers 316. Incoming communications from the payment gateways 18 are processed through the firewall 310 and routed to the frontend web servers 314 by the load balancers 312. The processing servers 316 communicate with the frontend web servers 314 and perform the main functions discussed herein, including querying the tax computation system 32 and transmitting transaction records to the transaction data store 34.

The transaction data store 34 includes reporting servers 320, 322 among which data replication is performed. The transaction data store 34 further includes a report generating server 324 and a backend reporting server 326, which generate reports for the taxation authority system 40.

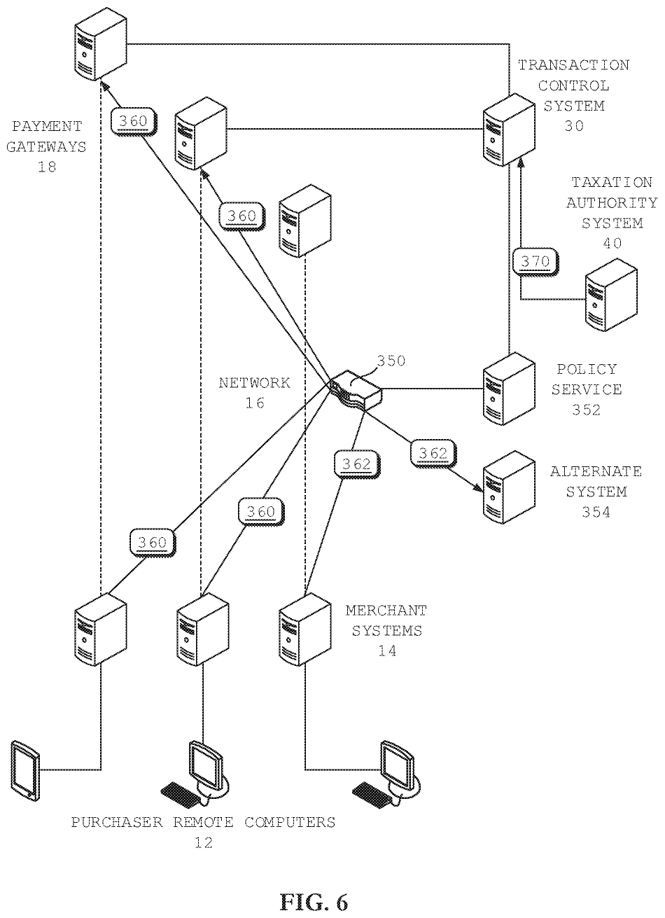

FIG. 6 shows a portion of the system of FIG. 1 with additional components showing how purchase requests to payment gateways 18 are controlled.

One or more routers 350 (or similar network infrastructure) are provided with one or more routing tables configured to route requests 360, 362 destined to payment gateways 18, such request tending to originate from merchant systems 14. The routing table lists low costs for routes to payments gateways 18 and lists a policy service 352 as the next hop for such low-cost routes. As such, requests 360, 362 from merchant systems 14 to payment gateways 18 will be routed to the policy service 352. The router 350 can further be configured to advertise to other routers its low-cost routes to the payment gateways 18, which results in a tendency for network traffic to the payment gateways 18 to be routed through the policy service 352.

In a particular tax jurisdiction, the policy service 352 includes at least one server situated at each internet gateway or at each telecom and internet service provider (ISP). The policy service 352 maintains a list of authorized and unauthorized payment gateways 18 for that tax jurisdiction. The policy service 352 is configured to forward each received request that is destined for an authorized payment gateway 18 to that payment gateway 18. Conversely, the policy service 352 is configured to discard or redirect each received request 362 that is destined for an unauthorized payment gateway 18.

The policy service 352 as a whole may be configured to operate in multiple tax jurisdictions. In such embodiments, the list of authorized and unauthorized payment gateways 18 specifies jurisdiction.

Requests 362 to unauthorized payment gateways 18 can be silently discarded, such that the merchant systems 14 operating in the tax jurisdiction are unable to contact such gateways 18. Alternatively, requests 362 to unauthorized payment gateways 18 can be redirected to one or more alternate systems 354. In some embodiments, an alternate system 354 include a message server that responds to requests 362 with a message that the requested payment gateway 18 is unauthorized to operate in this jurisdiction. In other embodiments, an alternate system 354 is an authorized or preferred payment gateway 18. In any event, requests to an unauthorized payment gateway 18 are intercepted and blocked from reaching the unauthorized payment gateway 18.

The transaction control system 30 can be configured to respond to commands 370 received from the taxation authority system 40. Such commands can include a command to grant authorization a payment gateway 18 and a command to revoke authorization of a payment gateway 18. The transaction control system 30 communicates such commands 370 to the policy service 352, which maintains the authorized/unauthorized status of each payment gateway 18 for the jurisdiction of the taxation authority system 40.

Numerous advantages of the present invention should be apparent from the above. For instance, payment gateways can be controlled by tax jurisdiction without requiring tight integration with the systems and processes of the payment gateways. No software agent is required to be installed or maintained at a payment gateway. The bidirectional API/web service communications according to the invention results in minimal change and disruption to the existing payment gateway systems and processes. Payment gateways can maintain their current levels of security and need not open up their systems to governments and other tax authorities.

Moreover, the present invention requires cooperation from as few entities as practical (i.e., the payment gateways) and such entities are generally already configured for effective network communication with other entities, such as bank and merchant systems. Hence, the transaction control system of the present invention offers an efficient and readily adopted way of controlling transactions to ensure that tax is collected.

In addition, the present invention provides one interface that serves two purposes, thereby further increasing efficiency in processing a large number of transactions. The transaction control system provides both tax lookups and transaction logging, which means that payment gateways need only communicate with the transaction control system to account for taxation.

The present invention further provides a single point of contact for many tens, hundreds, or thousands of payment gateways. Thus, each payment gateway need only configure its system to communicate with the transaction control system to deal with taxation matters for as many jurisdictions as are relevant to that payment gateway.

While the foregoing provides certain non-limiting examples, it should be understood that combinations, subsets, and variations of the foregoing are contemplated. The monopoly sought is defined by the claims.

What is claimed is:

1. A process for facilitating online transactions, the process comprising:
receiving transaction data from a payment gateway over a computer network, the transaction data representative of a pending transaction between a remote computer and an online merchant system, the transaction data including at least an indication of a location of the transaction and an amount of the transaction;
applying the transaction data to a database to obtain tax data for the pending transaction;
transmitting an indication of the tax data for the pending transaction to the payment gateway over the computer network;
receiving over the computer network from the payment gateway a transaction record that is representative of execution of the pending transaction between the remote computer and the online merchant system, execution of the pending transaction being performed using the tax data;
storing the transaction record in a data store; and
transmitting a record storage confirmation indicator to the payment gateway over the computer network.

2. The process of claim 1, wherein the record storage confirmation indicator is used by the payment gateway as a condition for reporting execution of the transaction to the online merchant system.

3. The process of claim 1, further comprising reporting data for a plurality of transaction records including the transaction record to a taxation authority system of a tax jurisdiction for the location.

4. The process of claim 3, further comprising receiving a command from the taxation authority system, and, in response to the command, intercepting requests from online merchant systems to the payment gateway and blocking the intercepted requests from reaching the payment gateway.

5. A system for facilitating online transactions, the system comprising:
a data store configured to store a plurality of transaction records;
a transaction control system configured to receive transaction data from a payment gateway over a computer network, the transaction data representative of a pending transaction between a remote computer and an online merchant system, the transaction data including at least an indication of a location of the transaction and an amount of the transaction;
the transaction control system further configured to apply the transaction data to a database to obtain tax data for the pending transaction;
the transaction control system further configured to transmit an indication of the tax data for the pending transaction to the payment gateway over the computer network;
the transaction control system further configured to receive over the computer network from the payment gateway a transaction record that is representative of execution of the pending transaction between the remote computer and the online merchant system, execution of the pending transaction being performed using the tax data;
the transaction control system further configured to transmit the transaction record to the data store; and
the transaction control system further configured to transmit a record storage confirmation indicator to the payment gateway over the computer network.

6. The system of claim 5, wherein the record storage confirmation indicator is used by the payment gateway as a condition for reporting execution of the transaction to the online merchant system.

7. The system of claim 5, wherein the data store is further configured to report data for a plurality of transaction records including the transaction record to a taxation authority system of a tax jurisdiction for the location.

8. The system of claim 7, wherein the transaction control system is further configured to receive a command from the taxation authority system, and, in response to the command, cause a policy service to intercept requests from online merchant systems to the payment gateway and block the intercepted requests from reaching the payment gateway.
